(19) United States
(12) Patent Application Publication
(10) Pub. No.: US 2019/0324658 A1
(43) Pub. Date: Oct. 24, 2019

(54) DYNAMIC MAXIMIZATION OF DRIVE THROUGHPUT WHILE MAINTAINING LATENCY QOS

(71) Applicant: Western Digital Technologies, Inc., San Jose, CA (US)

(72) Inventor: James WALSH, Santa Clara, CA (US)

(21) Appl. No.: 16/044,175

(22) Filed: Jul. 24, 2018

Related U.S. Application Data
(60) Provisional application No. 62/689,987, filed on Jun. 26, 2018.
(60) Provisional application No. 62/660,148, filed on Apr. 19, 2018.

(51) Int. Cl. G06F 3/06

(52) U.S. Cl. CPC G06F 3/0611; G06F 2003/0697; G06F 3/0688; G06F 3/0659

(57) ABSTRACT

A storage device and method of operation are provided to manage the latency quality of service of the storage device in order to increase the overall maximum drive throughput or bandwidth of the storage device. A drive of the storage device receives a request for latency quality of service status from a host, and provides the latency quality of service information to the host. The drive monitors the latency quality of service status of the storage device, and continues to provide latency quality of service status feedback to the host. The host may then dynamically adjust the data-queue depth limit based on the latency quality of service status feedback from the drive.

### CROSS-REFERENCE TO RELATED APPLICATIONS

This application claims benefit of U.S. Provisional Patent Application Ser. No. 62/660,148, filed Apr. 29, 2018, and U.S. Provisional Patent Application Ser. No. 62/689,987, filed Jun. 26, 2018, which are herein incorporated by reference.

### BACKGROUND OF THE DISCLOSURE

### Field of the Disclosure

Embodiments of the present disclosure generally relate to storage devices, such as solid state drives (SSDs).

### Description of the Related Art

SSDs may be used in computers in applications where relatively low latency and high capacity storage are desired. For example, SSDs may exhibit lower latency, particularly for random reads and writes, than hard disk drives (HDDs). Lower latency may allow greater throughput for random reads from and random writes to a SSD compared to a HDD. In such SSDs, hosts receive a certain latency quality of service (QoS) from the drives as a function of how busy the drive is, among other factors, such as a percentage of writes versus reads, and sequentiality of previous writes.

Typically, drives can only provide a predictably limited latency QoS, when the drive is not saturated with work. The drives are characterized to determine the data-queue depth at which the drives saturate, providing for a static data-queue depth limit to prevent saturation. A host then limits the data-queue depth submitted to the drive in order to receive a predictably limited latency QoS from the drive and to prevent oversaturation of the drive. As a result, the static data-queue depth limit may fail to utilize up to 15%-20% of throughput or bandwidth of the drive.

Therefore, there is a need in art for a storage system with a dynamic data-queue depth limit that can utilize all of the available throughput or bandwidth of the drive without impacting latency QoS.

### SUMMARY OF THE DISCLOSURE

A storage device and method of operation are provided to manage the latency QoS of the storage device in order to increase the overall maximum drive throughput or bandwidth of the storage device. A drive of the storage device receives a request for latency QoS status from a host, and provides the latency QoS information to the host. The drive monitors the latency QoS status of the storage device, and continues to provide latency QoS status feedback to the host. The host may then dynamically adjust the data-queue depth limit based on the latency QoS status feedback from the drive.

In one embodiment, a storage device comprises a command processor configured to monitor a latency QoS status and provide the latency QoS status feedback to a host, one or more memory devices coupled to the command processor, and a bandwidth limiter coupled to the command processor. The bandwidth limiter is configured to determine a bandwidth and determine whether the bandwidth is above or below a threshold value. The storage device further comprises a command fetch coupled to the bandwidth limiter. The command fetch is configured to send commands to the bandwidth limiter, and to temporarily pause fetching additional commands from the host and sending commands to the bandwidth limiter if the bandwidth limiter determines the bandwidth is over the threshold value.

In another embodiment, a storage device comprises a controller, one or more memory elements coupled to the controller, an interface coupled to the controller, and means for limiting bandwidth by managing a latency QoS status of the device by monitoring the latency QoS status and providing latency QoS status feedback to a host.

In another embodiment, a method of operating a storage device comprises receiving a request for a latency QoS status from a host, providing the latency QoS status to the host, monitoring the latency QoS status, and continuing to provide feedback about the latency QoS status to the host.

In yet another embodiment, a method of operating a storage device comprises receiving a command to enable and configure latency quality of service status monitoring from a host to a command processor, and providing latency QoS status feedback to the host. Providing latency QoS status feedback to the host comprises predicting the time needed to complete an input/output command, determining whether the predicted time is longer than a latency QoS target, aborting the input/output command if the predicated time is longer than the latency QoS target, and informing the host the input/output command was aborted, or receiving an explicit latency QoS status information request from the host, and sending the requested data to the host in response, or sending latency QoS information to the host under certain predetermined conditions.

In another embodiment, a storage system comprises a host device and a storage device coupled to the host device. The storage device further comprises a command processor configured to manage a latency QoS status of the device by monitoring the latency QoS status and providing latency QoS status feedback, one or more memory devices coupled to the command processor, and a command fetch coupled to the command processor. The host device is configured to submit requests to the command processor as needed to monitor the latency QoS status while keeping a data-queue depth under a current data-queue depth limit, and to dynamically adjust the data-queue depth limit based on the latency QoS status feedback provided by the command processor.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic block diagram illustrating a storage system in which a storage device may function as the storage device for a host device, according to one embodiment.

FIG. 2 illustrates a storage system comprising a drive coupled to a host device, according to another embodiment.

FIG. 3 illustrates a flowchart representing a method for operating a storage system, according to one embodiment.

FIGS. 4A-4C illustrate methods for providing latency QoS status feedback, according to another embodiment.

FIG. 5 illustrates a drive of a storage system, according to one embodiment.

FIG. 6 illustrates a flowchart of a method of operating a storage device having a bandwidth limiter, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Particular examples in accordance with the disclosure are described below with reference to the drawings. In the description, common features are designated by common reference numbers. As used herein, “exemplary” may indicate an example, an implementation, and/or an aspect, and should not be construed as limiting or as indicating a preference or a preferred implementation. Further, it is to be appreciated that certain ordinal terms (e.g., “first” or “second”) may be provided for identification and ease of reference and do not necessarily imply physical characteristics or ordering. Therefore, as used herein, an ordinal term (e.g., “first,” “second,” “third,” etc.) used to modify an element, such as a structure, a component, an operation, etc., does not necessarily indicate priority or order of the element with respect to another element, but rather distinguishes the element from another element having a same name (but for use of the ordinal term). In addition, as used herein, indefinite articles (“a” and “an”) may indicate “one or more” rather than “one.” As used herein, a structure or operation that “comprises” or “includes” an element may include one or more other elements not explicitly recited. Further, an operation performed “based on” a condition or event may also be performed based on one or more other conditions or events not explicitly recited.

A storage device and method of operation are provided to manage the latency QoS of the storage device in order to increase the overall maximum drive throughput or bandwidth of the storage device. A drive of the storage device receives a request for latency QoS status from a host, and provides the latency QoS information to the host. The drive monitors the latency QoS status of the storage device, and continues to provide latency QoS status feedback to the host. The host may then dynamically adjust the data-queue depth limit based on the latency QoS status feedback from the drive.

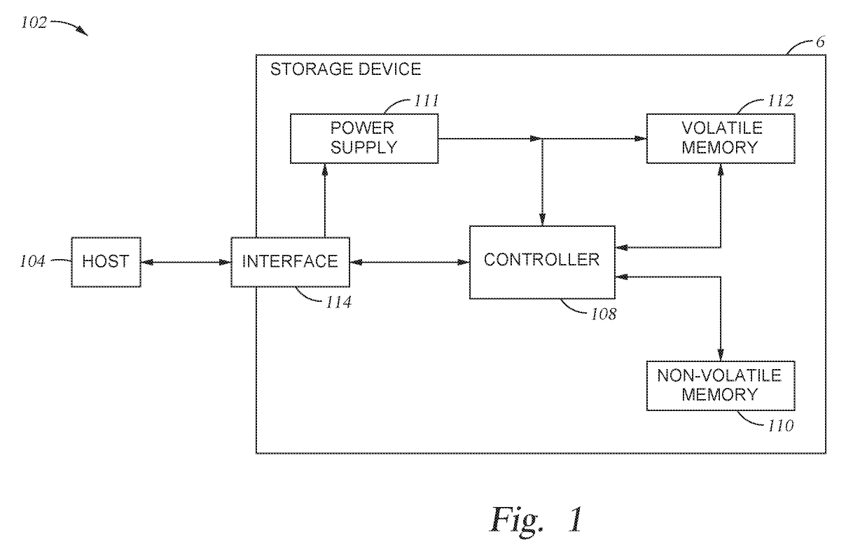

FIG. 1 is a conceptual and schematic block diagram illustrating a storage system 102 in which storage device 106 may function as a storage device for host device 104, in accordance with one or more techniques of this disclosure. For instance, host device 104 may utilize non-volatile memory devices included in storage device 106 to store and retrieve data. In some examples, storage system 102 may include a plurality of storage devices, such as storage device 106, which may operate as a storage array. For instance, storage system 102 may include a plurality of storages devices 106 configured as a redundant array of inexpensive/independent disks (RAID) that collectively function as a mass storage device for host device 104.

Storage system 102 includes host device 104 which may store and/or retrieve data to and/or from one or more storage devices, such as storage device 106. As illustrated in FIG. 1, host device 104 may communicate with storage device 106 via interface 114. Host device 104 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like.

As illustrated in FIG. 1, storage device 106 may include controller 108, non-volatile memory 110 (NVM 110), power supply 111, volatile memory 112, and interface 114. In some examples, storage device 106 may include additional components not shown in FIG. 1 for sake of clarity. For example, storage device 106 may include a printed board (PB) to which components of storage device 106 are mechanically attached and which includes electrically conductive traces that electrically interconnect components of storage device 106, or the like. In some examples, the physical dimensions and connector configurations of storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCl, etc.). In some examples, storage device 106 may be directly coupled (e.g., directly soldered) to a motherboard of host device 104.

Storage device 106 may include interface 114 for interfacing with host device 104. Interface 114 may include one or both of a data bus for exchanging data with host device 104 and a control bus for exchanging commands with host device 104. Interface 114 may operate in accordance with any suitable protocol. For example, interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), or the like. The electrical connection of interface 114 (e.g., the data bus, the control bus, or both) is electrically connected to controller 108, providing electrical connection between host device 104 and controller 108, allowing data to be exchanged between host device 104 and controller 108. In some examples, the electrical connection of interface 114 may also permit storage device 106 to receive power from host device 104. For example, as illustrated in FIG. 1, power supply 111 may receive power from host device 104 via interface 114.

Storage device 106 includes NVM 110, which may include a plurality of memory devices. NVM 110 may be configured to store and/or retrieve data. For instance, a memory device of NVM 110 may receive data and a message from controller 108 that instructs the memory device to store the data. Similarly, the memory device of NVM 110 may receive a message from controller 108 that instructs the memory device to retrieve data. In some examples, each of the memory devices may be referred to as a die. In some examples, a single physical chip may include a plurality of dies (i.e., a plurality of memory devices). In some examples, each memory devices may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory device of NVM 110 may include any type of non-volatile memory devices, such as flash memory devices, phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

Flash memory devices may include NAND or NOR based flash memory devices, and may store data based on a charge contained in a floating gate of a transistor for each flash memory cell. In NAND flash memory devices, the flash memory device may be divided into a plurality of blocks which may divided into a plurality of pages. Each block of the plurality of blocks within a particular memory device may include a plurality of NAND cells. Rows of NAND cells may be electrically connected using a word line to define a page of a plurality of pages. Respective cells in each of the plurality of pages may be electrically connected to respective bit lines. Controller 108 may write data to and read data from NAND flash memory devices at the page level and erase data from NAND flash memory devices at the block level.

Storage device 106 includes power supply 111, which may provide power to one or more components of storage device 106. When operating in a standard mode, power supply 111 may provide power to the one or more components using power provided by an external device, such as host device 104. For instance, power supply 111 may provide power to the one or more components using power received from host device 104 via interface 114. In some examples, power supply 111 may include one or more power storage components configured to provide power to the one or more components when operating in a shutdown mode, such as where power ceases to be received from the external device. In this way, power supply 111 may function as an onboard backup power source. Some examples of the one or more power storage components include, but are not limited to, capacitors, super capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

Storage device 106 also includes volatile memory 112, which may be used by controller 108 to store information. In some examples, controller 108 may use volatile memory 112 as a cache. For instance, controller 108 may store cached information in volatile memory 112 until cached information is written to non-volatile memory 110. As illustrated in FIG. 1, volatile memory 112 may consume power received from power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like)).

Storage device 106 includes controller 108, which may manage one or more operations of storage device 106. For instance, controller 108 may manage the reading of data from and/or the writing of data to non-volatile memory 110.

In some examples, controller 108 may measure latency in storage device 106 and record latency information about storage device 106. For example, if storage device 106 receives a read command from host device 104, controller 108 may initiate a data retrieval command to retrieve data from non-volatile memory 110 and monitor the progress of the data retrieval. In some examples, controller 108 may determine a time indicative of initiating the data retrieval command. For example, controller 108 may determine a time indicative of initiating the data retrieval command by determining a time when controller 108 received the read command from host device 104, began to execute the data retrieval command, or received a first data frame from non-volatile memory 110. In some examples, controller 108 may determine a time indicative of terminating the data retrieval command. For example, controller 108 may determine a time indicative of terminating the data retrieval command by determining a time when controller 108 received a last data frame from non-volatile memory 110, or sent a status frame (e.g., a frame indicating whether the data transfer was successful) to host device 104.

Likewise, if storage device 106 receives a write command from host device 104, controller 108 may initiate a data storage command to store data to non-volatile memory 110 and monitor the progress of the data storage command. In some examples, controller 108 may determine a time indicative of initiating the data storage command. For example, controller 108 may determine a time indicative of initiating the data storage command by determining a time when controller 108 received the write command from host device 104, began to execute the data storage command, or received a first data frame from host device 104. In some examples, controller 108 may determine a time indicative of terminating the data storage command. For example, controller 108 may determine a time indicative of terminating the data storage command by determining a time when controller 108 received a last data frame from host device 104, or sent a status frame (e.g., a frame indicating whether the data transfer was successful) to host device 104.

In some examples, controller 108 may measure latency in storage device 106 based on such timestamps. For example, controller 108 may determine an elapsed time between two timestamps and compare the elapsed time to a threshold amount of time. In response to determining that the elapsed time satisfies a threshold amount of time (e.g., the elapsed time is greater than threshold amount of time), controller 108 may determine at least one operational characteristic of storage system 102 and cause the at least one operational characteristic of storage system 102 to be stored to a memory device (e.g., non-volatile memory 110 or volatile memory 112). For example, operational characteristics may include controller register information, firmware data structures, firmware event history, host configured mode settings (e.g., formatted capacity, Power Modes, Encryption Modes, and the like), device state (e.g., amount of drive used, temperature of device, state of SMART parameters, etc.), host command sequence and history, and so on. Examples of firmware data structures may include performance and workload statistics, error statistics, and state information about non-volatile memory (such as amount of valid customer data and amount of memory ready to store new customer data). In some examples, controller 108 may store the operational characteristics in a system area of NVM 110.

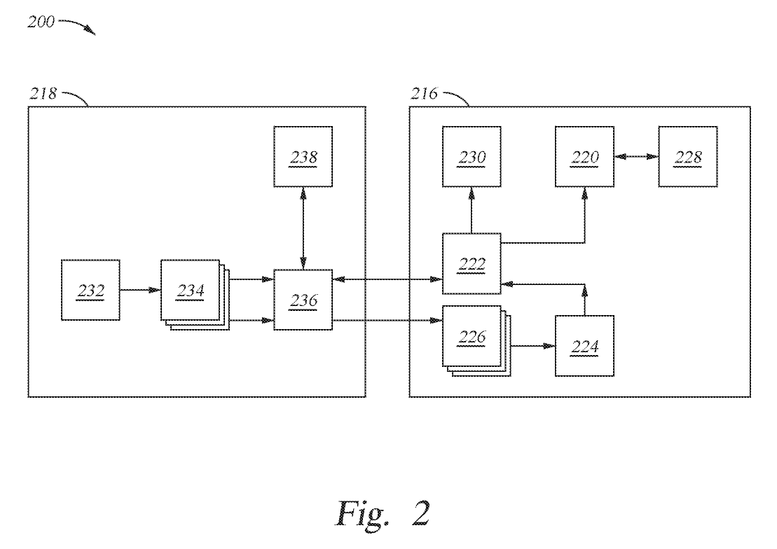

FIG. 2 illustrates a storage system 200 comprising a drive 216 coupled to a host device 218, according to one embodiment. Storage system 200 may be storage system 102 of FIG. 1. The drive 216 may be an SSD, and may be a component of controller 108 of FIG. 1, while host device 218 may be a component of host 104 of FIG. 1. Drive 216 may include an NVMe interface, and may be a subset of a larger drive or SSD of the device. The drive 216 includes a command processor 220. The command processor 220 may schedule NAND access, and may perform a read to a NAND device prior to a previously received command requiring a write to the same NAND device. The command processor 220 is coupled to a command fetch 222. The command fetch 222 is coupled to a submission queue arbitration 224. The submission queue arbitration 224 is coupled to one or more submission queue head and tail pointers 226. Additionally, the command processor 220 is coupled to one or more memory devices 228, and the command fetch 222 is coupled to a command table 230.

The host device 218 is comprised of one or more host software applications 232 coupled to one or more host drivers 234. The host drivers 234 are coupled to an interconnect 236. The interconnect 236 is coupled to a host DRAM 238 and to the drive 216. The host DRAM 238 may store submission queue data. The interconnect 236 may be in communication with both the submission queue head and tail pointers 226 and the command fetch 222.

The host driver 234 may limit data-queue depth submitted to the drive 216. Queue depth (QD) is the maximum number of commands queued to the drive 216, and data-QD is the amount of data associated with the commands queued with a QD. In one embodiment, the data-QD of the storage device is equal to the bandwidth of the storage device. Data-QD is limited to the highest level under which the drive 216 can still maintain a desired latency QoS. The host device 218 may select a target latency QoS for the storage system 200, and may also limit an associated data-QD of the storage system 200. For selecting the latency QoS target, the drive 216 may provide information to the host driver 234. Such information may include the latency QoS capabilities of the drive 216, an approximate maximum data-QD limit associated with a particular latency QoS target, and/or multiple pairs of data-QD limits or QoS target values. Additionally, the host device 218 may keep a data-QD of the system 200 under a current data-QD limit.

The host driver 234 may submit requests to the command processor 220 of the drive 216 as needed to monitor the latency QoS while keeping the data-QD of the system 200 under the current data-QD limit. The command processor 220 may monitor the latency QoS of the system 200 by receiving the request for the latency QoS status from the host driver 234 and providing the latency QoS feedback to the host device 218. The command processor 220 may monitor the latency QoS status continually, or until receiving a command from the host device 218 to cease monitoring the latency QoS status. Furthermore, the command processor 220 may continue to provide the latency QoS feedback to the host driver 234 as necessary. In response to receiving the latency QoS status from the command processor 220, the host driver 234 may dynamically adjust the data-QD limit. This allows the storage system 200 to provide for higher drive throughput while maintaining the desired latency QoS.

If one of the one or more host software applications 232 experiences a latency QoS exceeding the latency QoS target, that host software application 232 may limit the data-QD submitted to the host driver 234. If a plurality of the one or more host software applications 232 experience a latency QoS exceeding the latency QoS target, each of the plurality of host software applications 232 may limit the data-QD submitted to the host driver 234. The cumulative data-QD across all the host software applications 232 may be kept less than or equal to the data-QD limit that the host driver 234 submits to the drive 216. The host driver 234 and the one or more host software applications 232 may work in agreement to limit the data-QD and to determine what the data-QD limit is.

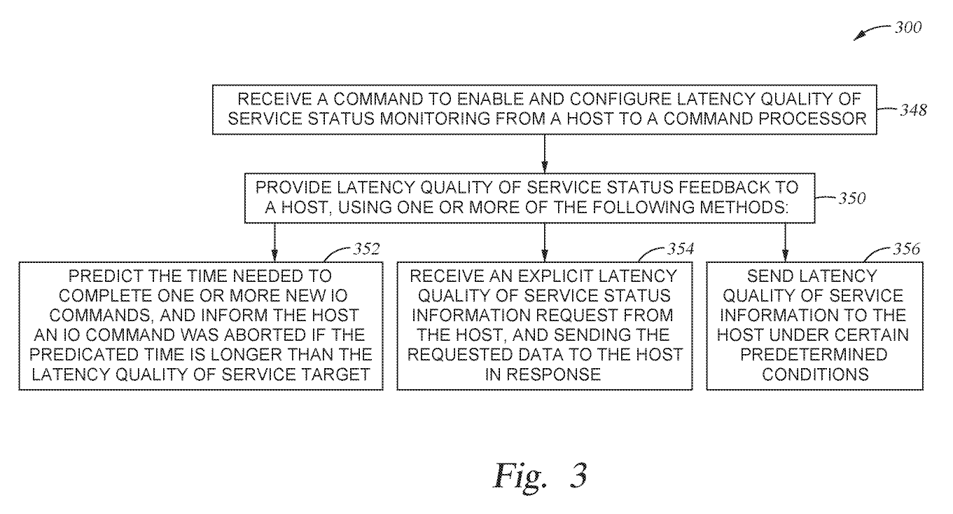

FIG. 3 illustrates a flowchart showing a method 300 of operating a storage system, according to another embodiment. Method 300 may be utilized to operate the storage system 200 of FIG. 2.

In operation 348, a command processor receives a command to enable and configure latency QoS status monitoring from a host. The command processor may be the command processor 220 of FIG. 2, and the host may be host device 218 of FIG. 2. In operation 350, the command processor provides latency QoS status feedback to the host.

The latency QoS status feedback and information of the storage device can include a variety of factors, used alone or in combination, in order to provide adequate feedback to the host. Such latency QoS status and information may include, but is not limited to: an indication that a fast fail event has occurred; a value indicating the total number of fast fail events that have occurred, or the number that have occurred since the last reported number, or other variations; a value indicating the number of submitted commands that exceed a specific QD limit or data-QD limit; a value indicating the average command latency per data-DQ unit over the time since the last reported value, or per a fixed time interval; and/or an indication that the average command latency has exceeded a specific threshold. The specific threshold may be a threshold associated with the drive hitting or narrowly exceeding a saturation limit, a threshold associated with the drive nearing but not hitting or exceeding a saturation limit, or a threshold associated with the drive significantly beyond exceeding a saturation limit. If the command processor provides feedback regarding the average command latency of the device, the host may increase the amount of data-QD limit in proportion to the current average command latency. If the command processor provides feedback regarding the number of fast fail events that occurred, the amount of data-queue depth limit may be decreased in proportion to the number of fast fail events that occurred.

Additional latency QoS status feedback and information may further include: command processing time for each command; current number of write buffers (i.e. write cache entries) full, or over a specific threshold; and/or current number of read buffers full, or over a specific threshold.

The command processor may provide the latency QoS status feedback to the host using one or more methods, which are illustrated in operation 352, operation 354, and operation 356. In operation 352, the command processor predicts the time needed to complete one or more new input/output (IO) commands, and informs the host an IO command was aborted if the predicted time is longer than the latency QoS target. In operation 354, the command processor receives an explicit latency QoS status request from the host, and sends the requested data to the host in response. In operation 356, the command processor sends latency QoS information to the host under certain predetermined conditions. Operations 352, 354, and 356, may be used alone or in combination, to provide the host with latency QoS status feedback.

Regarding operation 356 of method 300, the command processor may automatically send latency QoS status feedback to the host upon the occurrence of one or more predetermined conditions taking place. Such predetermined conditions may include, but are not limited to: a period rate; a specific submission queue QD limit being exceeded; a specific QD limit across a specific set of submission queues, or across all submission queues, being exceeded; a specific data-QD limit for a specific submission queue being exceeded; a specific data-QD limit across a specific set of submission queues, or across all submission queues, being exceeded; a specific threshold of fast fail events being exceeded; a specific threshold of fast fail events being exceeded within a specific period of time; a specific threshold of the average command latency being exceeded; a specific threshold of the processing time of a command being exceeded; a specific threshold of a number of write buffers full being exceeded; and/or a specific threshold of a number of read buffers full being exceeded.

Following operation 352, operation 354, and/or operation 356, the host device may dynamically adjust the data-QD limit of the storage device in response to the feedback received from the command processor. Additionally, the host device may continue to submit commands to the drive as needed while keeping the data-QD under the current data-QD limit. This allows the storage device to provide for higher drive throughput while maintaining the desired latency QoS.

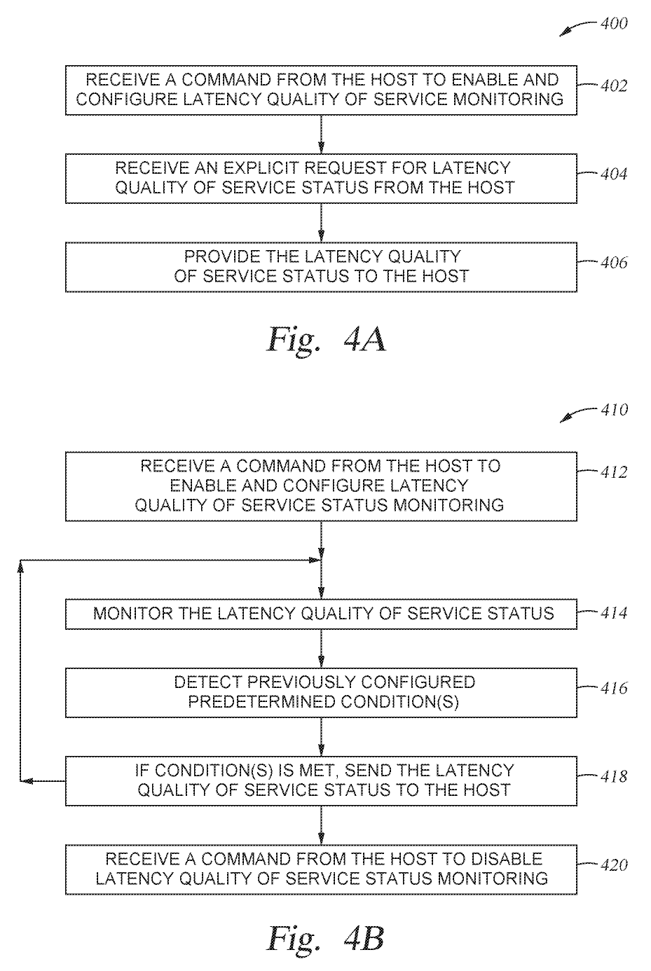

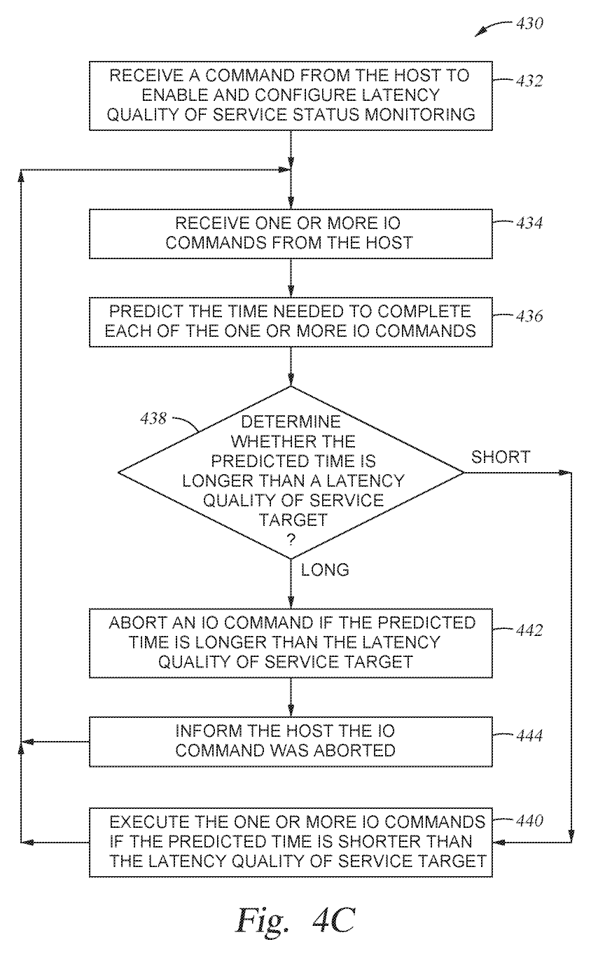

Method 300 of FIG. 3 may be used in combination with FIGS. 4A-4C. as such, FIGS. 4A-4C may be utilized to operate the storage system 200 of FIG. 2 comprising the command processor 220 and the host device 218.

FIGS. 4A-4C illustrate methods 400, 410, and 430 for providing latency QoS status feedback to a host. Specifically, FIGS. 4A-4C illustrate and elaborate on operations 352, 354, and 356 of method 300 of FIG. 3. FIG. 4A relates to operation 354 of FIG. 3, and illustrates a method 400 of the command processor receiving an explicit latency QoS status information request from the host. FIG. 4B relates to operation 356 of FIG. 3, and illustrates a method 410 of the command processor sending latency QoS information to the host under an example of a predetermined condition. FIG. 4C relates to operation 352 of FIG. 3, and illustrates a method 430 of the command processor predicting the time needed to complete one or more IO commands.

FIG. 4A exemplifies a method 400 relating to operation 354 of FIG. 3. In operation 402 of method 400 of FIG. 4A, a command processor receives a command from the host to enable and configure latency QoS monitoring. In operation 404, the command processor receives an explicit request for a latency QoS status from the host. In operation 406, the command processor provides the latency QoS status to the host. The host may then limit the associated data-QD as needed in response.

FIG. 4B exemplifies a method 410 relating to operation 356 of FIG. 3. In operation 412 of method 410 of FIG. 4B, a command processor receives a command from the host to enable and configure latency QoS monitoring. In operation 414, the command processor monitors the latency QoS. In operation 416, a previously configured predetermined condition(s) is detected, such as an exceeded bandwidth limit threshold. In operation 418, if the condition(s) are met, the command processor sends the latency QoS status to the host in response to the threshold being detected. The host may then limit the associated data-QD as needed in response. After completing operation 418, method 410 may repeat operations 414-418 one or more times. Operations 414-418 may be repeated until operation 420. In operation 420, the command processor receives a command from the host to disable the latency QoS monitoring.

An exceeded bandwidth limit threshold is only one example of a predetermined condition that may trigger the command processor to send latency QoS information to the host. It is to be understood other predetermined conditions may trigger the command processor to send latency QoS information to the host, such as any of the predetermined conditions discussed above with respect to operation 356 of FIG. 3. Additionally, method 410 may be applied to each predetermined condition that triggers the command processor to send latency QoS information to the host.

FIG. 4C exemplifies a method 430 relating to operation 352 of FIG. 3. In operation 432 of method 430 of FIG. 4C, a command processor receives a command from the host to enable and configure latency QoS monitoring. In operation 434, the command processor receives or fetches one or more IO commands from the host. In one embodiment, the IO commands are read commands and write commands. In operation 436, the command processor predicts the time needed to complete each of the one or more IO commands. In operation 438, the command processor determines whether the predicted time is longer than a latency QoS target.

If the command processor determines in operation 438 that the predicted time is shorter than the latency QoS target, the method 430 proceeds to operation 440. In operation 440, the one or more IO commands are executed. Following operation 440, method 430 may repeat operations 434-440 one or more times. Method 430 may repeat operations 434-440 until receiving a command from the host to disable latency QoS monitoring.

If the command processor determines in operation 438 that the predicted time is longer than the latency QoS target, the method 430 proceeds to operation 442. In operation 442, each of the one or more IO commands that are predicted to exceed the latency QoS target are aborted. The command processor then informs the host the IO command was aborted in operation 444. The host may then limit the associated data-QD as needed in response. Following operation 444, method 430 may repeat operations 434-444 one or more times. Method 430 may repeat operations 434-444 until receiving a command from the host to disable latency QoS monitoring.

In one embodiment, the command processor receives a plurality of IO commands from the host in operation 434. In such an embodiment, operation 440 and operations 442 and 444 may be executed simultaneously. For example, in operation 438, the command processor may determine that a first IO command has a predicted time shorter than the latency QoS target and a second IO command has a predicted time longer than the latency QoS target. The first IO command may be executed in operation 440 while the second IO command is aborted in operation 442.

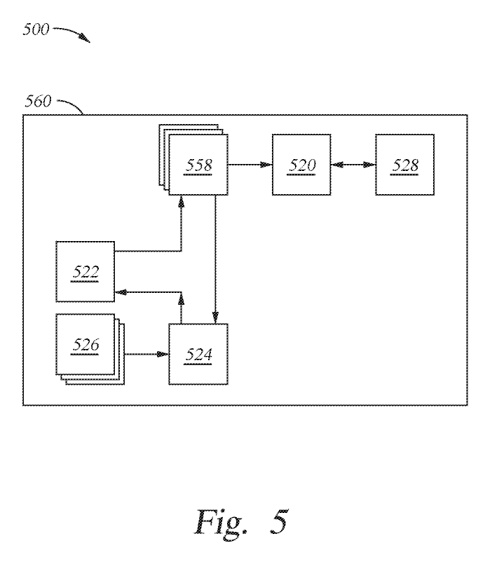

FIG. 5 illustrates a drive 560 of a storage system 500, according to one embodiment. The drive 560 may be used in storage system 200 in place of drive 216. The drive 560 may be coupled to a host device, and may be an SSD. The drive 560 includes one or more memory devices 528 coupled to a command processor 520. The command processor 520 is coupled to a bandwidth limiter 558. The bandwidth limiter 558 is coupled to a submission queue arbitration 524. The submission queue arbitration 524 is coupled to one or more submission queue head and tail pointers 526. The submission queue arbitration 524 is further coupled to a command fetch 522, and command fetch 522 is also coupled to the bandwidth limiter 558. Utilizing a bandwidth limiter 558 may allow a storage system to prioritize commands to be sent to the command processor 520.

The command processor 520 may be the command processor 220 from FIG. 2, the one or more memory devices 528 may be the one or more memory devices 228 of FIG. 2, the command fetch 522 may be the command fetch 222 of FIG. 2, the submission queue arbitration 524 may be the submission queue arbitration 224 of FIG. 2, and the one or more submission queue head and tail pointers 526 may be the one or more submission queue head and tail pointers 226 of FIG. 2. Additionally, the command processor 520, the one or more memory devices 528, the command fetch 522, the submission queue arbitration 524, and the submission queue head and tail pointers 526 may function in the same manner as their equivalents in FIG. 2. For example, the command processor 520 may monitor the latency QoS status and provide the latency QoS feedback to a host.

The command fetch 522 receives submission queue data commands from the submission queue arbitration 524. The command fetch then sends the submission queue data commands to the bandwidth limiter 558. The bandwidth limiter 558 may then determine a bandwidth of the drive 560, and determine whether the bandwidth is above or below a threshold value. In order to determine the bandwidth of the drive 560, the bandwidth limiter 558 determines a periodic byte count of the drive 560, subtracts the byte count of each new command received from the command fetch 522, and adds bytes periodically, such as every microsecond. The bandwidth limiter 558 continually updates and calculates the bandwidth of the drive 560 to limit the bandwidth of commands sent to the command processor 520 for processing.

Because the bandwidth limiter 558 subtracts the byte count of each new command received from the bandwidth total, the threshold value of the drive 560 may be determined and scaled to equal zero. As such, if the bandwidth is determined to be a negative value, or less than zero, the bandwidth would be below the threshold value. For the bandwidth limiter 558 to continue to receive commands from the command fetch 522, the bandwidth should be above the threshold value, and may be a value greater than or equal to zero.

If the bandwidth limiter 558 determines that the bandwidth is above the threshold value, the command fetch 522 temporarily pauses fetching additional commands from the host and sending submission queue data commands to the bandwidth limiter 558. The amount of time the command fetch 522 is temporarily paused is proportional to how far above the threshold value the bandwidth is determined to be. Thus, the command fetch 522 resumes sending the submission queue data commands to the bandwidth limiter 558 when the bandwidth limiter 558 determines the bandwidth is below the threshold value once again. The bandwidth limiter 558 may be configured to send a command to the command fetch 522 to temporarily pause fetching additional commands from the host and sending submission queue data commands or resume fetching additional commands from the host and sending submission queue data commands to the bandwidth limiter 558. Additionally, the command fetch 522 may be configured to receive such commands to pause or resume from the bandwidth limiter 558.

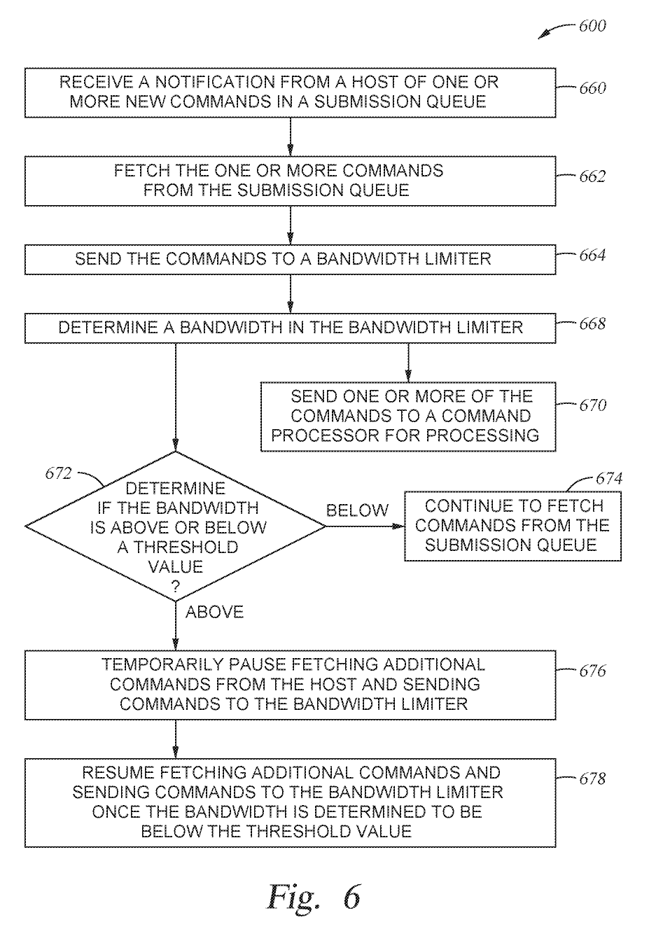

FIG. 6 illustrates a flowchart of a method 600 of operating a storage device having a bandwidth limiter, according to one embodiment. The method 600 may be used to operate the storage system 500 of FIG. 5. In operation 660, a drive receives a notification from a host of one or more new commands in a submission queue. The host may add new commands to the submission queue by adding the new command to an empty entry identified by a tail pointer and by incrementing the tail pointer to the next empty entry. The one or more new commands may be IO commands. In operation 662, a command fetch fetches the one or more commands from the submission queue. The command fetch may issue a host read command to an entry of the submission queue identified by a head pointer. In operation 664, the command fetch sends the commands to the bandwidth limiter.

In operation 668, the bandwidth limiter determines the bandwidth of the drive. Additionally, in operation 670, the bandwidth limiter sends one or more of the commands to the command processor for processing. Operation 668 and operation 670 may occur simultaneously, or operation 668 may occur prior to operation 670, or operation 670 may occur prior to operation 668. The order in which operations 668 and 670 are performed may be a predetermined configuration of the bandwidth limiter.

In operation 672, the bandwidth limiter determines if the bandwidth of the drive is above or below a threshold value. If the bandwidth is determined to be below the threshold value, the method 600 proceeds to operation 674. If the bandwidth is determined to be above the threshold value, the method 600 moves on to operation 676. In operation 674, the bandwidth limiter continues to fetch commands from the submission queue. Following operation 674, the method 600 may repeat and start again from operation 660. In one embodiment, the method 600 may begin from either operation 662 or operation 664.

In operation 676, the command fetch temporarily pauses fetching additional commands from the host and sending commands to the bandwidth limiter. The command fetch may temporarily pause fetching additional commands from the host and sending commands to the bandwidth limiter for so long as the bandwidth is determined to be above the threshold value. In operation 678, the command fetch resumes fetching additional commands from the host and sending commands to the bandwidth limiter once the bandwidth is determined to be below the threshold value. Following operation 678, the method 600 may repeat and start again from operation 660 or operation 662. In one embodiment, the method 600 may begin from operation 664.

The above described methods of operation provide for improved storage devices. Specifically, the methods allow the drive of the storage device to dynamically communicate the data-QD limit and saturation status information with a host, permitting the host to dynamically adjust the data-QD. By monitoring the latency QoS status and continuing to provide feedback regarding the latency QoS status, the data-QD limit can be altered in response to drive saturation changes without impacting the latency QoS. A dynamic data-QD limit allows for the overall maximum drive throughput or bandwidth of the device to be increased and fully utilized without oversaturation, while maintaining the latency QoS.

In one embodiment, a storage device comprises a command processor configured to monitor a latency QoS status and provide the latency QoS status to a host, one or more memory devices coupled to the command processor, and a bandwidth limiter coupled to the command processor. The bandwidth limiter is configured to determine a bandwidth and determine whether the bandwidth is above or below a threshold value. The storage device further comprises a command fetch coupled to the bandwidth limiter. The command fetch is configured to send commands to the bandwidth limiter, and to temporarily pause sending commands to the bandwidth limiter if the bandwidth limiter determines the bandwidth is above the threshold value.

The storage device may further comprise a submission queue arbitration coupled to the bandwidth limiter, and a plurality of submission queue head and tail pointers coupled to the submission queue arbitration. The command fetch may be further configured to resume sending commands to the bandwidth limiter after the bandwidth limiter determines the bandwidth is below the threshold value. The command processor may be further configured to receive commands from the bandwidth limiter. The amount of time the command fetch is temporarily paused is proportional to how far above the threshold value the bandwidth is determined to be.

In another embodiment, a storage device comprises a controller, one or more memory elements coupled to the controller, an interface coupled to the controller, and means for limiting bandwidth by managing a latency QoS status of the device by monitoring the latency QoS status and providing latency QoS status feedback to a host.

The latency quality of service status may include a value indicating the average command latency per data-queue depth unit over a fixed interval of time. The latency quality of service status may include an indication that the average command latency has exceeded a specific threshold. The amount of data-queue depth limit may increase in proportion to the current average command latency. The controller may comprise a command fetch.

In another embodiment, a method of operating a storage device comprises receiving a request for a latency QoS status from a host, providing the latency QoS status to the host, monitoring the latency QoS status, and continuing to provide feedback about the latency QoS status to the host.

The latency quality of service status may include a value indicating the number of submitted commands that exceed a specific queue depth limit or data-queue depth limit. The latency quality of service status may include an indication that a fast fail event occurred, or a value indicating the total number of fast fail events that have occurred. The amount of data-queue depth limit may decrease in proportion to the number of fast fail events that occurred. The latency quality of service status may include a target latency quality of service and an associated data-queue depth limit.

In yet another embodiment, a method of operating a storage device comprises receiving a command to limit associated data-queue depth from a host to a command processor, and providing latency QoS feedback to the host. Providing latency QoS feedback to the host comprises predicting the time needed to complete an input/output command, determining whether the predicted time is longer than a latency QoS target, aborting the input/output command if the predicated time is longer than the latency QoS target, and informing the host the input/output command was aborted, or receiving an explicit latency QoS status information request from the host, and sending the requested data to the host in response, or sending latency QoS information to the host under certain predetermined conditions.

The predetermined conditions may include a periodic rate. The predetermined conditions may comprise a specific threshold of fast fail events being exceeded, or a specific threshold of fast fail events being exceeded within a specific time period. The predetermined conditions may include a specific threshold of the processing time of the command is exceeded. The predetermined conditions may include a specific data-queue depth limit for a specific submission queue being exceeded.

In another embodiment, a storage system comprises a host device and a storage device coupled to the host device. The storage device further comprises a command processor configured to manage a latency QoS of the device by monitoring the latency QoS status and providing latency QoS feedback, one or more memory devices coupled to the command processor, a command fetch coupled to the command processor, and a submission queue arbitration coupled to the command fetch. The host device is configured to submit requests to the command processor as needed to monitor the latency QoS while keeping a data-queue depth under a current data-queue depth limit, and to dynamically adjust the data-queue depth limit based on the latency QoS feedback provided by the command processor.

The host device may include a host driver, a host dynamic random-access memory, and one or more host software applications. The storage system may further comprise a bandwidth limiter coupled to the command processor. The bandwidth limiter may be configured to determine a bandwidth and determine whether the bandwidth is above or below a threshold value. The host device may be further configured to select a target latency quality of service for the storage device. The host device may be further configured to limit an associated data-queue depth of the storage device.

While the foregoing is directed to implementations of the present disclosure, other and further implementations of the disclosure may be devised without departing from the basic scope thereof, and the scope thereof is determined by the claims that follow.

What is claimed is:

1. A storage device, comprising:
a command processor configured to monitor a latency quality of service status and provide the latency quality of service status to a host;
one or more memory devices coupled to the command processor;
a bandwidth limiter coupled to the command processor, the bandwidth limiter configured to determine a bandwidth and determine whether the bandwidth is above or below a threshold value; and
a command fetch coupled to the bandwidth limiter, the command fetch configured to send commands to the bandwidth limiter, and to temporarily pause sending commands to the bandwidth limiter if the bandwidth limiter determines the bandwidth is over the threshold value.

2. The storage device of claim 1, further comprising a submission queue arbitration coupled to the bandwidth limiter, and a plurality of submission queue head and tail pointers coupled to the submission queue arbitration.

3. The storage device of claim 1, wherein the command fetch is further configured to resume sending commands to the bandwidth limiter after the bandwidth limiter determines the bandwidth is below the threshold value.

4. The storage device of claim 1, wherein the command processor is further configured to receive commands from the bandwidth limiter.

5. The storage device of claim 1, wherein the amount of time the command fetch is temporarily paused is proportional to how far above the threshold value the bandwidth is determined to be.

6. The storage device of claim 1, wherein the command fetch is further configured to temporarily pause fetching commands from the host if the bandwidth limiter determines the bandwidth is over the threshold value.

7. The storage device of claim 6, wherein the command fetch is further configured to resume fetching commands from the host after the bandwidth limiter determines the bandwidth is below the threshold value.

8. A storage device, comprising:
a controller;
one or more memory elements coupled to the controller;
an interface coupled to the controller; and
means for limiting bandwidth by managing a latency quality of service status of the storage device by monitoring the latency quality of service status and providing latency quality of service status feedback to a host.

9. The storage device of claim 8, wherein the latency quality of service status includes a value indicating an average command latency per data-queue depth unit over a fixed interval of time.

10. The storage device of claim 9, wherein the latency quality of service status includes an indication that the average command latency has exceeded a specific threshold.

11. The storage device of claim 10, wherein the amount of data-queue depth limit increases in proportion to the current average command latency.

12. The storage device of claim 8, wherein the controller comprises a command fetch.

13. A method of operating a storage device, comprising:
receiving a request for a latency quality of service status from a host;
providing the latency quality of service status to the host;
monitoring the latency quality of service status; and
continuing to provide feedback about the latency quality of service status to the host.

14. The method of claim 13, wherein the latency quality of service status includes a value indicating the number of submitted commands that exceed a specific queue depth limit or data-queue depth limit.

15. The method of claim 13, wherein the latency quality of service status includes an indication that a fast fail event occurred, or a value indicating the total number of fast fail events that have occurred.

16. The method of claim 15, wherein the amount of data-queue depth limit decreases in proportion to the number of fast fail events that occurred.

17. The method of claim 13, wherein the latency quality of service status includes a target latency quality of service and an associated data-queue depth limit.

18. A method of operating a storage device, comprising:
receiving a command to enable and configure latency quality of service status monitoring from a host to a command processor; and
providing latency quality of service status feedback to the host, comprising:
predicting the time needed to complete an input/output command, determining whether the predicted time is longer than a latency quality of service target, aborting the input/output command if the predicted time is longer than the latency quality of service target, and informing the host the input/output command was aborted; or
receiving an explicit latency quality of service status information request from the host, and sending the requested data to the host in response; or
sending latency quality of service information to the host under certain predetermined conditions.

19. The method of claim 18, wherein the predetermined conditions include a periodic rate.

20. The method of claim 18, wherein the predetermined conditions comprise: a specific threshold of fast fail events being exceeded, or a specific threshold of fast fail events being exceeded within a specific time period.

21. The method of claim 18, wherein the predetermined conditions include a specific threshold of the processing time of the command is exceeded.

22. The method of claim 18, wherein the predetermined conditions include a specific data-queue depth limit for a specific submission queue being exceeded.

23. A storage system, comprising:
a host device; and
a storage device coupled to the host device, the storage device comprising:
a command processor configured to manage a latency quality of service status of the storage device by monitoring the latency quality of service status and providing latency quality of service status feedback;
one or more memory devices coupled to the command processor; and
a command fetch coupled to the command processor, wherein the host device is configured to submit requests to the command processor as needed to monitor the latency quality of service status while keeping a data-queue depth under a current data-queue depth limit, and to dynamically adjust the data-queue depth limit based on the latency quality of service status feedback provided by the command processor.

24. The storage system of claim 23, wherein the host device includes a host driver, a host dynamic random-access memory, and one or more host software applications.

25. The storage system of claim 23, further comprising a bandwidth limiter coupled to the command processor, the bandwidth limiter configured to determine a bandwidth and determine whether the bandwidth is above or below a threshold value.

26. The storage system of claim 23, wherein the host device is further configured to select a target latency quality of service for the storage device.

27. The storage system of claim 23, wherein the host device is further configured to limit an associated data-queue depth of the storage device.
